(19) United States
(12) Patent Application Publication
(10) Pub. No.: US 2003/0134677 A1
(43) Pub. Date: Jul. 17, 2003

(54) Method and apparatus for generating real-time embedded software for a chance game

(76) Inventors: Salah Obied, Phoenix, AZ (US); Garth A. Ripton, Tehachapi, CA (US); Anussorn Andy Veradej, Las Vegas, NV (US)

Correspondence Address: Michael J. Blankstein, WMS Gaming Inc., 800 South Northpoint Boulevard, Waukegan, IL, 60085, US

(21) Appl. No.: 09/965,429

(22) Filed: Sep. 27, 2001

(51) Int. Cl. A63F 13/00

(52) U.S. Cl. 463/42

(57) ABSTRACT

A method and apparatus for generating real-time embedded software code for a game of chance from formal design models. Much of the software code is automatically generated using an off-the-shelf, object-oriented, fully integrated, software development tool in which the software developer can analyze, model, design, implement, and verify the behavior of the embedded software.

### FIELD OF THE INVENTION

The present invention relates generally to real-time embedded software for a game of chance and, more particularly, to a method and apparatus for automatically generating such software from formal design models.

### BACKGROUND OF THE INVENTION

A gaming machine is operable to play a game of chance, such as slots, poker, bingo, keno, and blackjack. The gaming machine includes a gaming controller with a processor and system memory. The system memory stores game application software and audiovisual resources associated with the game of chance. The memory may, for example, comprise a separate read-only memory (ROM) and battery-backed random-access memory (RAM). However, it will be appreciated that the system memory may be implemented on any of several alternative types of alterable and non-alterable memory structures or may be implemented on a single memory structure. In response to a wager, the processor executes the game application software which, based on a randomly determined outcome, selectively accesses the audiovisual resources to be shown on a video display and played through one or more speakers mounted to a housing of the gaming machine. If the outcome corresponds to a winning outcome typically identified on a pay table, the processor instructs a payoff mechanism to award a payoff for that winning outcome to the player in the form of coins or credits.

In the gaming industry, less expensive and more powerful hardware, escalating functional requirements, fewer software engineering resources, and the drive to reduce time-to-revenue are putting tremendous pressure on real-time embedded software developers to produce more capable software in less time with fewer defects. Game application software is a key to providing market differentiation. Faster, better, and cheaper methods of developing such software are critical to meeting the demands of the market.

In recent history, marginal improvements have been made to the tools used by game software developers in the gaming industry. These tools, however, have continued to focus on assisting the developer to write, compile, link, and debug software code at the lowest levels. No solutions have been offered to leapfrog these manual development tasks. The software development process is essentially unchanged, even as development demands have increased exponentially and as software has become more complex especially through the use of more interactive game play, more complex game play sequences, and full-motion multimedia. While chip development has been automated, software development has remained primarily a manual process. The typical way of dealing with this has been to (1) commit more resources to software development if such resources are affordable and can be found and/or (2) cut back on functionality when a project runs late.

In the software development process traditionally employed in the gaming industry, planning is somewhat separated from implementation. Planning involves such elements as customer requirements, written specifications, analysis, design, and prototype. Implementation involves such elements as hand writing code, low level code debugging, testing code, and iterating for different releases of the product. The plan and its documentation are somewhat static, which means that design changes made after the plan is created may never be reflected until after the product is finished. The plan documentation may become obsolete as implementation is done on the fly. The software developer never really validates the behavior of his or her design until after integration. Also, software developers are often good at programming but are weak at documentation. The majority of software developers may complete the code but many may fail to update or create the accompanying documentations. Therefore, it is often difficult to maintain or to expand the software.

### SUMMARY OF THE INVENTION

To overcome the aforementioned problems generally associated with software development in the gaming industry, the present invention is directed to a method and apparatus for generating real-time embedded software code for a game of chance from formal design models. Much of the software code is automatically generated using an off-the-shelf, object-oriented, fully integrated, software development tool in which the software developer can analyze, model, design, implement, and verify the behavior of the embedded software. Because the software is automatically updated as the models are changed and the documents can be generated by the software development tool, the software is easier to maintain which, in turn, means that the time to market is minimized.

### BRIEF DESCRIPTION OF THE DRAWINGS

The foregoing and other advantages of the invention will become apparent upon reading the following detailed description and upon reference to the drawings.

FIG. 1 is a perspective view of a gaming machine operable to execute game software developed in accordance with the present invention;

FIG. 2 is a block diagram of a control system suitable for operating the gaming machine;

FIG. 3 shows a use case diagram in an analysis model on a system level for playing a game;

FIG. 4 shows a sub-use case diagram for evaluating a slot game successfully;

FIG. 5 shows a sequence diagram in the analysis model for how the various subsystems interact to play a game;

FIG. 6 shows a sequence diagram for evaluating a slot game successfully, i.e., evaluating pay line and other wins for a slot game;

FIG. 7 shows an object model diagram in a design model for evaluating a slot game; and

FIG. 8 shows a state chart in the design model for a CReelGroup object included in the object model diagram of FIG. 7.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

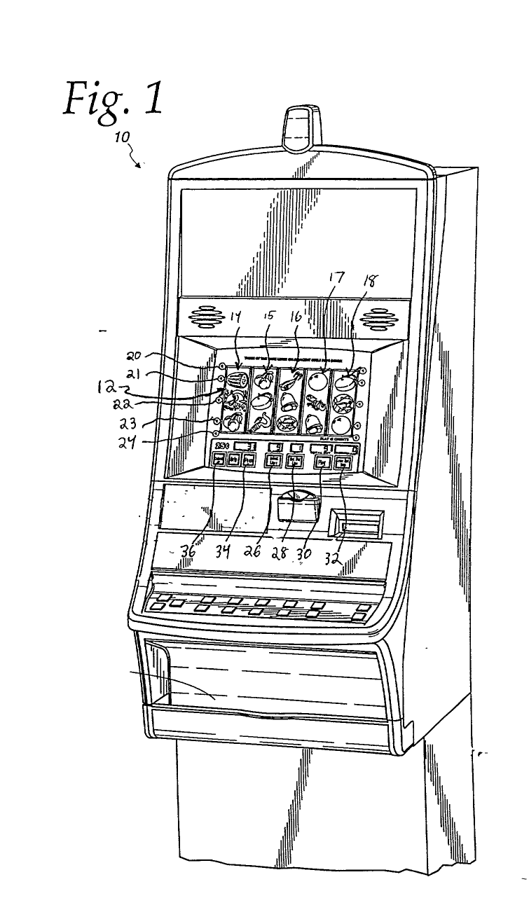

Turning to the drawings, FIG. 1 depicts a gaming machine 10 operable to play a game of chance such as slots, poker, bingo, keno, and blackjack. The gaming machine 10 includes a visual display 12 preferably in the form of a dot matrix, CRT, LED, LCD, electro-luminescent, or other type of video display known in the art. The display 12 preferably includes a touch screen overlaying the monitor. In the illustrated embodiment, the gaming machine 10 is an “upright” version in which the display 12 is oriented vertically relative to the player. Alternatively, the gaming machine may be a “slant-top” version in which the display 12 is slanted at about a thirty-degree angle toward the player of the gaming machine 10.

In one embodiment, the gaming machine 10 is operable to play a basic slot game with five simulated spinning reels 14, 15, 16, 17, and 18 and a bonus game triggered by a start-bonus outcome in the basic game. Each of five or more pay lines 20, 21, 22, 23, and 24 extends through one symbol on each of the five reels. Generally, game play is initiated by inserting a number of coins or playing a number of credits, causing a game controller to activate a number of pay lines corresponding to the number of coins or credits played. In one embodiment, the player selects the number of pay lines (between one and five) to play by pressing a “Select Lines” key 26 on the video display 12. The player then chooses the number of coins or credits to bet on the selected pay lines by pressing a “Bet Per Line” key 28.

After activation of the pay lines, the reels 14-18 may be set in motion by touching a “Spin Reels” or “Play” key 30 or, if the player wishes to bet the maximum amount per line, by using a “Max Bet Spin” key 32 on the video display 12. Alternatively, other mechanisms such as, for example, a lever or push button may be used to set the reels in motion. The game controller uses a random number generator to select a game outcome (e.g., “basic” game outcome) corresponding to a particular set of reel “stop positions.” The game controller then causes each of the video reels to stop at the appropriate stop position. Video symbols are displayed on the reels to graphically illustrate the reel stop positions and indicate whether the stop positions of the reels represent a winning game outcome.

Winning basic game outcomes (e.g., symbol combinations resulting in payment of coins or credits) are identifiable to the player by a pay table. In one embodiment, the pay table is affixed to the machine 10 and/or displayed by the video display 12 in response to a command by the player (e.g., by pressing a “Pay Table” button 34). A winning basic game outcome occurs when the symbols appearing on the reels 14-18 along an active pay line correspond to one of the winning combinations on the pay table. A winning combination, for example, could be three or more matching symbols along an active pay line, where the award is greater as the number of matching symbols along the active pay line increases. If the displayed symbols stop in a winning combination, the game credits the player an amount corresponding to the award in the pay table for that combination multiplied by the amount of credits bet on the winning pay line. The player may collect the amount of accumulated credits by pressing a “° Collect” button 36. In one implementation, the winning combinations start from the first reel 14 (left to right) and span adjacent reels. In an alternative implementation, the winning combinations start from either the first reel 14 (left to right) or the fifth reel 18 (right to left) and span adjacent reels.

Included among the plurality of basic game outcomes is a start-bonus outcome to for triggering play of a bonus game. A start-bonus outcome may be defined in any number of ways. For example, a start-bonus outcome may occur when a special start-bonus symbol or a special combination of symbols appears on one or more of the reels 14-18. The start-bonus outcome may require the combination of symbols to appear along an active pay line, or may alternatively require that the combination of symbols appear anywhere on the display regardless of whether the symbols are along an active pay line. The appearance of a start-bonus outcome causes the game controller to shift operation from the basic game to the bonus game.

The bonus game may be played on the video display 12 or a secondary mechanical or video bonus indicator distinct from the video display 12. If the bonus game is played on the video display 12, the bonus game may utilize the reels 14-18 or may replace the reels with a different display image. The bonus game may be interactive and require a player to make one or more selections to earn bonus amounts. Also, the bonus game may depict one or more animated events and award bonus amounts based on an outcome of the animated events. Upon completion of the bonus game, the game controller shifts operation back to the basic slot game.

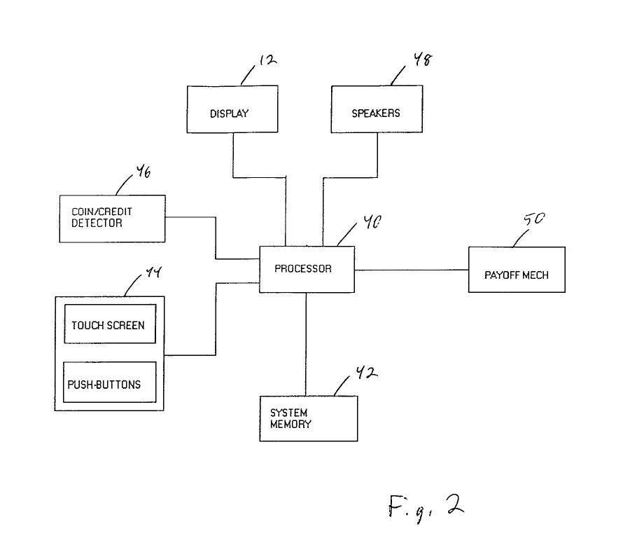

FIG. 2 is a block diagram of a control system suitable for operating the gaming machine. The control system includes a processor 40 and system memory 42. The system memory 42 stores game application software and audiovisual resources associated with the game of chance played on the gaming machine. The memory 42 may, for example, comprise a separate read-only memory (ROM) and battery-backed random-access memory (RAM). However, it will be appreciated that the system memory 42 may be implemented on any of several alternative types of alterable and non-alterable memory structures or may be implemented on a single memory structure. The player may select an amount to wager and other game play functions via touch screen or push-button input keys 44. The wager amount is signaled to the processor 40 by a coin/credit detector 46, which registers a number of coins deposited by the player or a number of credits played. The processor converts the number of deposited coins to a number of credits based on a coin-to-credit ratio. In response to the wager, the processor 40 executes the game application software which, based on a randomly determined outcome, selectively accesses the audiovisual resources to be shown on the video display 12 and played through one or more audio speakers 48 mounted to a housing of the gaming machine. If the outcome corresponds to a winning outcome typically identified on a pay table, the processor 40 instructs a payoff mechanism 50 to award a payoff for that winning outcome to the player in the form of coins or credits.

In accordance with the present invention, the real-time embedded game application software in the memory 42 is developed using a unique software development process. Specifically, much of the software code is automatically generated from formal design models using an off-the-shelf, object-oriented, fully integrated, software development tool in which the software developer can analyze, model, design, implement, and verify the behavior of the embedded software. This software development tool may, for example, be the Rhapsody® visual programming environment commercially available from I-Logix Inc. of Andover, Mass. The Rhapsody® tool may be used in conjunction with different programming languages, including C, C++, and Java. The Rhapsody® tool provides a complete visual programming environment that conforms to the Unified Modeling Language (UML) standard and integrates the entire software development process into one “associative” environment. This means that the software developer's design, software code, and documentation will always be in sync so that the software developer will not draw and maintain static pictures representing analysis and design decisions separate from the software code.

By automatically generating complete production quality code from design models, the software development tool shifts the focus of work from coding (e.g., writing the software, compiling, linking, and debugging at the assembly and source code levels) to design, with significant improvements in total productivity. By enabling executables to animate design models, the focus of work remains at the design level throughout debugging and verification. The software development tool saves time by eliminating much of the tedious, time-consuming, code-level debugging and, as a result, allows increased focus on software design while actually reducing cycle times. More attention can be paid to such high-risk factors as designing the right product, building a credible design, and delivering the application source code in a well-documented, maintainable, and reusable format.

As an example, the process of developing some of the game application software for playing a slot game on an electronic gaming machine (EGM) is described below. The software development process includes an “analysis model” phase, a “design model” phase, and a “code generation” phase. Each of these phases are preferably implemented with an “associative” visual programming environment like Rhapsody®.

The “analysis model” describes the functionality to be included in the software. The analysis model organizes high-level functionality into use cases. The analysis model shows relationships between use cases and elements outside the system, called actors, in use case diagrams. Some use cases for the gaming machine on a system level are handling money, playing a game, handling critical events, and servicing the machine. The example described herein focuses on the game play use case. The primary actors for game play are the player, the money handling function, the host, and the random number generator (RNG). They are the elements outside of game play that are used to complete a game. For example, the player's input is needed to wager and start a game. Money must be input into the machine (via the handle money function) before a player can wager.

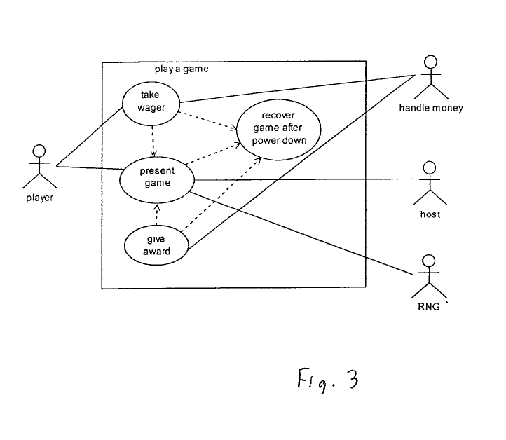

FIG. 3 shows a use case diagram on a system level for playing a game. This use case diagram employs the following elements and functionality:

| Element | Type | Functionality |
|---|---|---|
| give | use case | Interaction with the money handling system to |
| award | | transfer credits to the money handling function |
| | | after they are awarded to player. |
| | | Presentation of award information to player |
| | | (possibly |
| | | including multimedia content). |
| | | Coordination with the game to assure game specific |
| | | award information is displayed. |
| | | Communication of game data with the host system. |
| handle | actor | It is responsible for the physical and logical money |
| money | | handling functions. The game play system level |
| | | use case relies on “handle money” to keep track of |
| | | player's credit balance for wagering. |
| host | actor | The game play system level use case reports game |
| | | activities to the host. |
| player | actor | The game play system level use case relies on the |
| | | player to initiate a game and to provide input |
| | | (“interactive” player choices) during a game. |
| present | use case | Initiation of a game (both the parts common to all |
| game | | games and the parts specific to a given game like |
| | | video slot or poker). |
| | | Evaluation of a game based on game rules and pay |
| | | tables to determine what will be presented to the |
| | | player and, ultimately, if the player will win |
| | | anything. |
| | | Presentation of game multimedia content (graphic |
| | | and sound) during game play. |
| | | Interaction with the player during the game if the |
| | | specific game requires that the player make |
| | | choices. |
| | | Presentation of game results whether the player has |
| | | won anything or not. |
| | | Communication of game data with the host system. |
| recover | use case | Recover the state of game play after loss of power. |
| game | | |
| after | | |
| power | | |
| down | | |
| RNG | actor | Represents the EGM's random number generator. |
| take wager | use case | Interaction with the money handling system to |
| | | transfer credits from the money handling function |
| | | when the player makes a wager. |
| | | Handling the interface that allows the player to |
| | | control the wager amount. |
| | | Presentation of wagering information to the player. |
| | | Coordination with the game to assure game specific |
| | | wager information is updated. |
| | | Communication of game data with the host system. |

Use case functionality is defined by asking what the system is supposed to do. The “success” scenario below is an example of such a description.

1. Player wagers a portion of his/her available credits on the game.

2. EGM (electronic gaming machine) displays the wager on the game screen by highlighting wager lines.

3. Player starts the game using EGM game control functions (“start button”).

4. EGM determines game outcome (final reel position).

5. EGM cocks slot reels and “spins” (animates) them for a set duration.

6. EGM stops each reel in succession at the predetermined position.

7. Player wins credits as the result of the game.

8. EGM displays winning game result to the player by highlighting the win-line(s).

9. EGM awards the credits won to the player.

The success scenario outlines, ideally, how the player plays a video slot game—from wagering through conclusion of the game. Exception scenarios (not shown) may describe other ways of playing a game that are not as clear cut or direct as is the main success scenario. Such exception scenarios could, for example, include the required behavior of the system when an error occurs (e.g., power failure recovery) or could describe a normal but alternate way of playing a game (e.g., changing the wager before starting a game). By looking at the scenarios, the use case may be further subdivided into more refined areas of functionality (“sub-use cases”), such as processing the player's wager, presenting the game to the player, evaluating the game successfully, and processing the player's award.

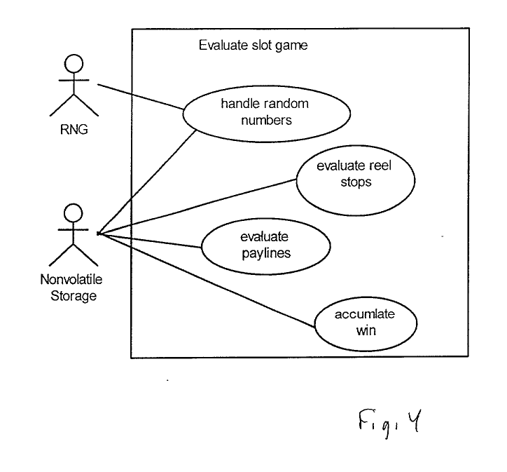

FIG. 4, for example, shows a sub-use case diagram for evaluating a slot game successfully. This sub-use case diagram employs the following elements and functionality:

| Element | Type | Functionality |
|---|---|---|
| accumulate | use case | Accumulating the wins across all pay lines |
| win | | and non-pay lines (e.g., scatter pays, etc.). |
| | | Arriving at the total number of credits won on a |
| | | given game. |
| evaluate | use case | Matching between the reel |
| pay lines | | symbols that are under a |
| | | given pay line and the winning symbol |
| | | combinations in the game's pay table. The pay |
| | | table indicates the number of credits won if the |
| | | symbols under a given pay line match a winning |
| | | symbol combination in the pay table. |
| evaluate | use case | Determining the positions at |
| reel | | which the reels stop at |
| stops | | the conclusion of the game. |
| handle | use case | Getting a random number. |
| random | | Scaling the random number into the proper range. |
| numbers | | Mapping the random number to reel |
| | | stop positions. |
| nonvolatile | actor | Represents the EGM's persistence capabilities and |
| storage | | may be realized by the subsystem that handles |
| | | battery-backed nonvolatile memory. |
| RNG | actor | Represents the EGM's random number generator. |

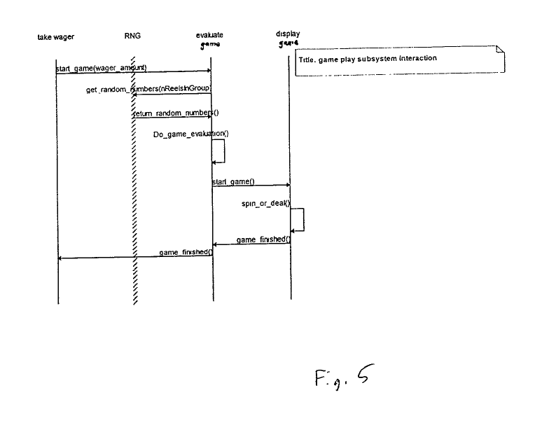

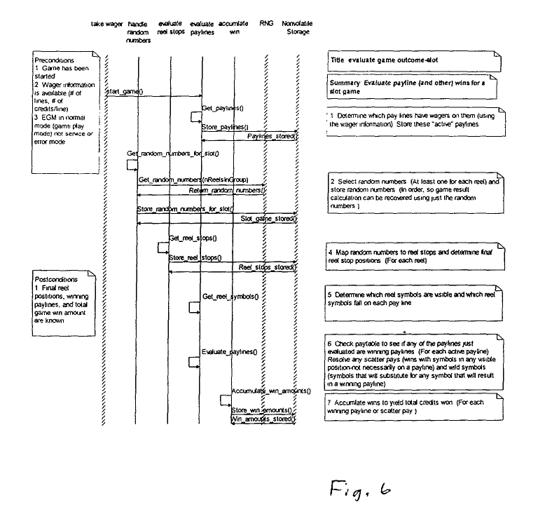

Scenarios can be outlined in text (as above for the “success” scenario) or shown in sequence diagrams. Sequence diagrams show the interactions between use cases and actors in more detail than use case diagrams. They indicate what information is flowing between the use case and actors and in what order. For example, game presentation is initiated when the player requests that the game play use case start the game. The player sends a message requesting the start of game. There are many other interactions between the player and the game play functions that are described in other sequence diagrams. When taken as a whole, all the scenarios, written or drawn as sequence diagrams, describe the behavior included in the use case. For example, FIG. 5 shows a sequence diagram for how the various subsystems interact to play a game. FIG. 6 shows a sequence diagram for evaluating a slot game successfully, i.e., evaluating pay line and other wins for a slot game.

The “design model” uses the analysis model to determine the functions it will realize. The individual use cases of the analysis model may be realized by a group of design level elements called “objects”. The process of creating objects to implement use case functionality is the heart of the design model phase described below. To judge whether the design is correct and complete, the software developer references the use cases to assure that he or she has all the required functionality covered.

The design model shows the elements that implement the use cases. The use cases are “mined” for objects that actually perform the functions they describe. In most cases, multiple objects collaborate to yield a use case's functionality. The transition between the analysis model and the design model requires switching from describing what the system does to defining how the system does it. Creating a clear, efficient, and good design model from a set of requirements or use cases relies upon the experience and insight of the software developer.

In the process of defining objects, the easiest objects to define are the physical real-world objects that exist as part of the system. A physical piece of hardware (a peripheral or hardware component) will usually have software objects that interface to and control it. For example, just as there is a physical coin handling device, a coin acceptor, there is a coin acceptor object that contains the logical interface between the device and the rest of the system. These types of objects can often be gleaned from a written description of system functionality (or system requirements). Other objects are purely software constructs, such as accounting objects, protocol handling objects, and system level control objects. Such objects often accomplish higher level functions. There are also low level objects that create, maintain, select, and link other objects. These types of low level objects are usually the last ones to be defined because they perform housekeeping functions for the other objects responsible for system functions.

Groups of objects collaborate in different ways. This gives rise to the different types of relationships between objects that are defined and described using the UML standard. A simple association relationship (symmetric) implies that the objects can communicate with each other via some means. A composite relationship means one object “owns” another and the composite object (the owner) is responsible for the creation and destruction of the subordinate object (the owned). These are just two types of relationships out of many that are defined in the UML standard.

The relationships between objects are shown on object model diagrams. An object model diagram usually shows how one or more objects interact to carry out system functions. The scope of the diagram—the number of objects and number of relationships—depends on the context of diagram. Generally, a single diagram has a single purpose. This could be an overview of object collaboration or a description of a specific function. The object model diagram is a static view of the system. It indicates how objects relate to one another without describing how they behave over time or the actual information that flows between them. This is left to design level state charts and activity diagrams described below.

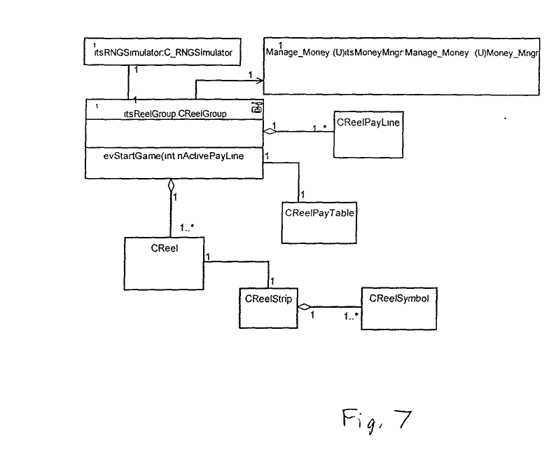

FIG. 7, for example, shows an object model diagram for evaluating a slot game. The object model diagram includes a plurality of linked boxes representing 30 objects or “classes”. A “class” is an abstract version of an object. Objects with similar responsibilities and/or behaviors can be instances of a single class. The term “object” is employed in the discussion below, but it should be understood that this term as used herein also encompasses of the abstraction of objects into classes. An object is shown as a box with a name, “attributes”, and “operations”. An “attribute” (also called a “member variable”) is a named value that an object is responsible for maintaining. An “operation” (also called a “method”) is a function that an object knows how to do and in UML is placed in the lowest compartment of a three-compartment box. The object model diagram in FIG. 7 employs the following objects:

| Object | Attributes | Operations |
|---|---|---|
| C_RNGSimulator | | GetRandNumber |
| This is here for | | Signature: GetRandNumber( ) |
| prototyping only and may | | SeedRNG |
| be replaced by a random | | Signature: SeedRNG( ) |
| number generator | | |
| subsystem. | | |
| CReel | m_ReelPosition:int | CReel |
| An individual reel that | A description of the static position | Signature: CReel(int |
| has a reel strip with one | of the reel. Used for win line | nReelStripSize,int |
| or more reel symbols. | evaluation. | nReelWindowSize,int * |
| This is a “logical” | m_ReelStripSize:int | pReelStripData) |
| version of a reel. Given | m_ReelWindowSize:REEL_WIN | GetReelSymbolValueAt |
| the reel's position and the | DOW_SIZES | Signature: |
| size of the visible | Describes the visible portion of the | GetReelSymbolValueAt(int |
| “window”, one knows | reel strip—the part the player can | ReelStop) |
| which reel symbols on | see on the display | For a given reel stop position, returns |
| the reel strip are visible. | | the reel symbol integer value (from |
| | | CReelSymbol) at that position |
| CReelGroup | m_anReelRandoms | AccumulateWin |
| The reel group is the | Provides temporary storage for the | Signature: AccumulateWin( ) |
| logical collection of | random numbers that determine the | Combine the total win of all of the |
| elements (objects) that | reel positions | active pay lines to get the win |
| are needed to do a slot | m_nReelPayLines:int | amount for the current game |
| reel evaluation. This | Number of pay lines | ClearPayLineWins |
| includes the reels | m_nReels:int | Signature: ClearPayLineWins( ) |
| themselves, the pay lines | Number of reels | Sets the win amount for each pay line |
| (that intersect with one or | m_TotalCreditsWon:int | to zero. This should be done when a |
| more reels), and the pay | The number of credits won during a | new game starts or when the game |
| table that maps reel | game from all active pay lines | win information is no longer needed. |
| symbols under the pay | | CReelGroup |
| lines to slot wins. The | | Signature: CReelGroup(int nReels,int |
| reel group is a type of | | nPayLines, void * pReelPayTable) |
| evaluation group | | GetRandoms |
| (analogous to a card hand | | Signature: GetRandoms( ) |
| in a poker game). | | This function gets one random |
| | | number for each reel and stores the |
| | | random numbers in a safe place. It |
| | | also “scales” the random number in |
| | | to the range from 0 to the reel strip |
| | | size. |
| | | GetReelSymbolsOnPayLines |
| | | Signature: |
| | | GetReelSymbolsOnPayLines( ) |
| | | This function uses the current reel |
| | | (reel strip) position and the pay line |
| | | geometry to determine which reel |
| | | symbols are on the given pay line |
| | | GetWinningPayLines |
| | | Signature: GetWinningPayLines( ) |
| | | This operation reads each pay table |
| | | entry and sees if the symbols on the |
| | | active pay lines (determined in |
| | | GetReelSymbolsOnPayLines( )) |
| | | match the pay table entry. If they do |
| | | then the pay line is a winning pay |
| | | line. |
| | | IsSubstituteSymbol |
| | | Signature: IsSubstituteSymbol(int |
| | | nPayLineSymbol,int |
| | | nPayTableSymbol) |
| | | Determines if the given symbol can |
| | | be substituted for any other symbols |
| | | in a set. This operation is used in |
| | | matching pay table symbols to pay |
| | | line symbols. |
| | | IsWildSymbol |
| | | Signature: IsWildSymbol(int |
| | | nPayLineSymbol) |
| | | Determines if the given reel symbol |
| | | substitutes for any other reel symbol |
| | | PayLineMatchesPayTableEntry |
| | | Signature: |
| | | PayLineMatchesPayTableEntry(CReel |
| | | PayLine* |
| | | pPayLine, |
| | | REEL_PAY_TABLE_ENTRY_{—} |
| | | TYPE* pPayTableEntry) |
| | | Does the actual work of pay table/pay |
| | | line matching (used by |
| | | GetWinningPayLines) |
| | | SetActivePayLines |
| | | Signature: SetActivePayLines(int |
| | | nActivePayLineCount,int |
| | | nCreditsPerActivePayLine) |
| | | Given the number of pay lines bet |
| | | and the number of credits bet per pay |
| | | line, set pay line active flag and save |
| | | the number of credits bet on each |
| | | active pay line |
| | | SetReelStops |
| | | Signature: SetReelStops( ) |
| | | Goes through each reel and sets the |
| | | new stop position using the random |
| | | numbers drawn by GetRandoms |
| CReelPayLine | m_PayLineActive:OMBoolean | CReelPayLine |
| This logical object | “True” if pay line has one or more | Signature: CReelPayLine(int |
| contains a map that | credits wagered on it. “False” if pay | nPayLineLength,int * pPayLineData) |
| indicates the positions at | line has no credits wagered on it. | |
| which the line intersects | m_PayLineLength:int | |
| with the visible part of | The number of position indexes in | |
| the reel (“reel window”). | the pay line (usually equal to the | |
| | number of reels for the game). The | |
| | position index is the position in the | |
| | reel window—visible part of the | |
| | reel—where the pay line intersects. | |
| | The position index is relative to the | |
| | top of the reel window. | |
| | m_PayLineReelSymbolIntValues: | |
| | An array that holds the current reel | |
| | symbol values that are in the | |
| | positions where the pay line | |
| | intersects each reel. The reel | |
| | symbol values are the “integer” | |
| | indexes stored in the CReelSymbol | |
| | object. | |
| | m_PayLineWager:int | |
| | How many credits are wagered on | |
| | this pay line | |
| | m_PayLineWin:int | |
| | The number of credits for this pay | |
| | line win. This pay line matches a | |
| | winning combination in the pay | |
| | table. | |
| | m_PositionIndexMap: | |
| | This array contains the position | |
| | index for each point in a pay line. | |
| | There is usually one intersection | |
| | point for each reel so the length of | |
| | the array usually equals the number | |
| | of reels. The position index value | |
| | indicates which part of the reel | |
| | window—the visible part of the | |
| | reel strip—the pay line intersects. | |
| | For example if the reel window is 3 | |
| | reel positions (the standard reel | |
| | window for most of games—top, | |
| | middle, bottom) then the position | |
| | index can be 0 (top), 1 (middle), or | |
| | 2 (bottom). | |
| CReelPayTable | m_PayTableSize:int | CReelPayTable |
| The pay table is used for | Number of entries in the pay table | Signature: CReelPayTable(int |
| evaluating whether or not | m_pPayTableEntry: | nPayTableSize,REEL_PAY_TABLE_{—} |
| pay lines are winning pay | Pointer to the first entry in the pay | ENTRY_TYPE |
| lines. They map a | table | *pPayTableEntryData) |
| combination of reel | | |
| symbols to a win amount. | | |
| CReelStrip | m_ReelStripMap: | CReelStrip |
| An “ordered array” of | This maps a reel strip position to a | Signature: CReelStrip(int |
| reel symbols that are part | reel symbol. It is an array of | nReelStripSize,int * pReelStripData) |
| of a reel. The reel strip | pointers to reel symbol objects. | GetReelSymbolValue At |
| wraps around so that the | m_ReelStripSize:int | Signature: |
| final reel symbol is next | This is the number of reel stops on | GetReelSymbolValueAt(int |
| to the first reel symbol. | the reel strip. It should correspond | nReelStop) |
| | to the number of reel symbols plus | Get the value—integer index—of the |
| | the number of blanks, if any. | reel symbol that is at the given reel |
| | | stop position |
| | | InitReelStripMap |
| | | Signature: InitReelStripMap(int * |
| | | pReelStripData) |
| | | This operation copies reel strip data |
| | | from a data file into the reel strip |
| | | map attribute |
| CReelSymbol | m_ReelSymbolIntValue:int | CReelSymbol |
| The logical | An integer index value | Signature: CReelSymbol(int |
| representation of the | | SymbolIntValue) |
| element that appears on | | |
| each position of the reel | | |
| strip. Currently this is just | | |
| an integer index. This | | |
| means that this does not | | |
| need to be an object and | | |
| could be folded into the | | |
| reel strip object as an | | |
| attribute. | | |
| Money_Mngr | | |
| (See Money Handling | | |
| Model) | | |

The design model divides system implementation into subsystems. A subsystem is a collection—a “package” in UML terminology—that performs a large-scale system function. By creating subsystems, the design model is divided into areas that can be implemented independently. A subsystem will often have a defined interface to the other subsystems that communicate with it. If outside elements only use this interface, then they do not have to know about any of the internal details of the subsystem. Examples of subsystems in a gaming application are the user interface, multimedia content player, and administration manager.

The behavior of the objects may be described in state charts or activity diagrams. The discussion below focuses on state charts. The object model diagram shows the static relationships between objects, and the state chart shows the internal dynamic actions of an object. The state chart shows all the discrete conditions of being or states of an object. A state is a condition in which an object spends a distinct amount of time. A simple example is a switch object with two states. It can be either “on” or “off”. The transitions between states occur as a result of information received by the object like the occurrence of an external event or a change in state in a different object. In the switch example, the event that caused the transition from “off” to “on” could be the “flip switch on” event. The transitions can be simple or complex. The transition between some states is automatic and in other cases is conditional (subject to a guard condition). The object can do work, such as call a function, during the transition, upon entering a state, or upon exiting a state. The work done upon entry or exit is called an action. While in a given state the object can also do work. This is called an activity, which starts after the transition into the state is complete and can be interrupted when the object makes the transition out of the state. The definitions that pertain to state behavior are given in detail in the UML specification, which is commercially available at various web sites on the Internet.

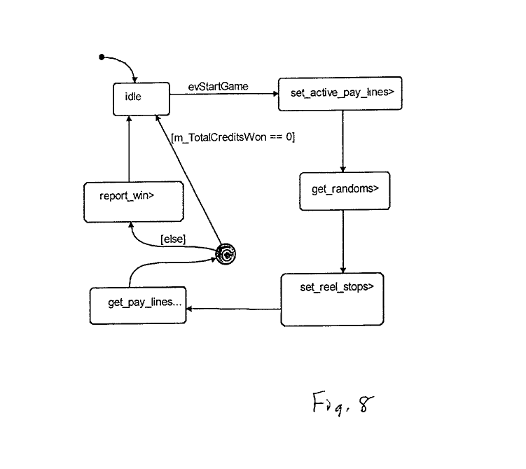

FIG. 8, for example, shows a state chart for the CReelGroup object included in the object model diagram of FIG. 7.

The design model for a slot game includes descriptions of the objects (the functions they implement and data they own), their relationships outlined in object model diagrams, and their behavior shown in state charts. Such a design model forms a sufficient basis for creating software code in the “code generation” phase to implement the design model. The design model describes how the system will accomplish the requirements set forth in the analysis model.

Using the well-defined notation of the UML standard allows the transition from the design model to software code in the “code generation” phase to be a simple translation. In accordance with the present invention, much of the software code is automatically generated. The automatically generated code is the code that defines the relationships between objects (defined in the object model diagrams) and the dynamic behavior of the objects (defined in the state charts). The relationships are realized in the software code using pointers between objects. The state transitions, actions and activities that occur while an object is in the various states are defined by the software developer in the state chart diagram. Software code that implements the state behavior is automatically generated. Code is also automatically generated for accessing and changing the attributes of an object that are “public”. The software developer explicitly declares an attribute “public” if other objects need to access it. Generally, the software developer attempts to minimize the number of attributes that are public to create clean, maintainable code.

The automatically generated code is generated with the aid of the same visual programming environment (e.g., Rhapsody®) that was used to prepare the analysis and design models. The Rhapsody® tool has the ability to automatically generate software code from UML design models. As stated above, all of the relationships between objects as shown in object model diagrams, as well as the behavior described in state charts, can be automatically translated into functional code. This makes moving from design to code implementation relatively easy.

Traditionally, the design models were used during a translation phase as a basis for manually creating software code. The disadvantage of this is that the inevitable changes made at the code level affected the design. If the changes were not reflected back into the design artifacts (UML diagrams), then the software code and the design began to diverge. After code modifications, the design no longer reflected the software code that was actually running, meaning the behavior of the system was different than the designed behavior. The use of automatic code generation, in accordance with the present invention, coupled with the ability to “round trip” helps to avoid this problem. Round tripping means that modifications that are made at the code level are automatically incorporated into the UML design models. In the reverse of the design-to-code translation, code changes are automatically translated into design model changes by a tool like Rhapsody®. This allow for synchronization of the design model and the software code regardless of which one is modified.

In addition to the automatically generated software code, portions of code must be manually inserted. This can be done within the implementation section of the Rhapsody® tool so that all the code is available within the design model. The manually inserted code is needed to call to external library functions and do work within state chart transitions and states. The manually inserted code is the body of the operations (the object “methods”) and deals specifically with the work performed by these operations. In the slot game example, the manually inserted code includes mapping of random numbers to reel stops, determining the reel symbols that intersect each pay line, and accumulating the win amounts for all the pay lines.

Below are excerpts from a Rhapsody® generated header (definition) file for the “CReel” object included in the object model diagram of FIG. 7. The file contains definitions of the operations and attributes for the object. It should be noted that the code examples below are generated in C++. Other forms of object-oriented source code such as Java can be generated using different code generation modules or applications.

/**********************************************************
***********

| | Rhapsody : 3.0 | | |
|---|---|---|---|
| | Login | : | gripton |
| | Component | : | gamePlay |
| | Configuration | : | MSVC genaric |
| | Model Element | : | CReel |
| //! | Generated Date | : | Tue, 3, Jul 2001 |
| | File Path | : | gamePlay\MSVC genaric\CReel.h |

***********************************************************
**********/

The header file section below shows the constructor, which is responsible for the creation of a CReel object, and the destructor, which is responsible for the deletion and destruction of the object. Because the constructor is user defined (it needs several parameters provided by the software developer in order to create itself), the Rhapsody® tool uses the developer's custom definition. The destructor, on the other hand, is standard, so its definition is automatically generated. It should be noted that the comment “//## auto_generated” appears before each portion of automatically generated code.

//## class CReel
class CReel {
//// Constructors and destructors ////
public:

// Argument int * pReelStripData:
// Points to the reel strip map data so we can set which symbol is at which reel stop.
//## operation CReel(int, int, int *)
CReel(int nReelStripSize = 24, int nReelWindowSize = 3, int * pReelStripData = NULL);
//## auto_generated
˜CReel( );

The operations in the first header file section below are the user defined “methods” of the CReel object. The only operation in this case is “GetReelSymbolValueAt (int ReelStop)”. This operation returns the reel symbol value at a given reel stop position. The second header file section below defines the automatically generated operations that are used to access and change the object member data. The “get” functions retrieve internal data (such as the reel position stored in “m_ReelPosition”). The “set” functions change the internal data. The Rhapsody® tool automatically generates these “accessor” and “mutator” functions unless the data is “private” to the object. These functions provide a consistent way to access object member data.

//// Operations ////
public:

// For a given reel stop position, returns the reel symbol integer value (from CReelSymbol) at

that position.

//## operation GetReelSymbolValueAt(int)
int GetReelSymbolValueAt(int ReelStop);

//// Additional operations ////
public:

//## auto_generated
int getM_ReelPosition( ) const;
//## auto_generated
void setM_ReelPosition(int p_m_ReelPosition);
//## auto_generated
int getM_ReelStripSize( ) const;
//## auto_generated
void setM_ReelStripSize(int p_m_ReelStripSize);
//## auto_generated
REEL_WINDOW_SIZES getM_ReelWindowSize( ) const;
//## auto_generated
void setM_ReelWindowSize(REEL_WINDOW_SIZES p_m_ReelWindowSize);
//## auto_generated
CReelGroup* getItsCReelGroup( ) const;
//## auto_generated
void setItsCReelGroup(CReelGroup* p_CReelGroup);
//## auto_generated
CReelStrip* getItsCReelStrip( ) const;
//## auto_generated
void setItsCReelStrip(CReelStrip* p_CReelStrip);

//// Framework operations ////
public:

//## auto_generated
void _setItsCReelGroup(CReelGroup* p_CReelGroup);
//## auto_generated
void _setItsCReelGroup(CReelGroup* p_CReelGroup);
//## auto_generated
void_clearItsCReelGroup( );
//## auto_generated
void _setItsCReelStrip(CReelStrip* p_CReelStrip);
//## auto_generated
void _setItsCReelStrip(CReelStrip* p_CReelStrip);
//## auto_generated
void _clearItsCReelStrip( );

protected:

//## auto_generated
void cleanUpRelations( );

The header file section below contains the user defined attributes—the data that is associated with this object.

//// Attributes ////
protected:

// A description of the static position of the reel. Used for win line evaluation.
int m_ReelPosition; //## attribute m_ReelPosition
int m_ReelStripSize; //## attribute m_ReelStripSize
// Desribes the visible portion of the reel strip- the part the player can see on the display
REEL_WINDOW_SIZES m_ReelWindowSize; //## attribute m_ReelWindowSize

The header file section below defines the relationships between this object and other objects as seen in the object model diagram of FIG. 7. Each reel (“CReel” object) is associated with a reel group (“CReelGroup”). A reel has a single reel group while a reel group has one or more reels. Because the relationship between a reel and its reel group is single in multiplicity, it is defined by a pointer to a reel group. The same applies for the relationship between a reel and its reel strip. Therefore, the Rhapsody® tool creates a pointer to each object with which the CReel object shares a relationship. It should be noted that in a situation where an object has more than one of a certain other object—an aggregation or composition relationship—the Rhapsody® tool creates a pointer to each one and manages them in a collection or list.

//// Relations and components ////
protected:

// Standard reel multiplicities include 3 and 5 per reel group.
CReelGroup* itsCReelGroup; //## link itsCReelGroup
CReelStrip* itsCReelStrip; //## link itsCReelStrip

};
/*********************************************************
************
File Path : gamePlay\MSVC genaric\CReel.h
************************************************************
*********/

Below are excerpts from a Rhapsody® generated implementation (in C++) file for the “CReel” object included in the object model diagram of FIG. 7. The Rhapsody® tool has automatically generated “framework” code as well as user defined code. The user defined code is delimited by the comment block “//#[<user code>//#]”:

/*********************************************************
************

| | Rhapsody : 3.0 | | |
|---|---|---|---|
| | Login | : | gripton |
| | Component | : | gamePlay |
| | Configuration | : | MSVC genaric |
| | Model Element | : | CReel |
| //! | Generated Date | : | Tue, 3, Jul 2001 |
| | File Path | : | gamePlay\MSVC genaric\CReel.cpp |

************************************************************
*********/

Below is the implementation of the constructor for CReel. Most of the software code for this method is user defined (from about the third line on). The constructor takes three parameters: reel strip size, reel window size, and a pointer to the reel strip's data. In this case, the reel object creates its own reel strip using the reel strip size and data parameters. It also uses the parameters to set several of CReel's attributes (such as “m_ReelStripSize” and “m_ReelWindowSize”).

CReel::CReel(int nReelStripSize, int nReelWindowSize,
int * pReelStripData) {

itsCReelGroup = NULL;
itsCReelStrip = NULL;
//#[ operation CReel(int, int, int *)
// Create the reel strip for this reel
m_ReelStripSize = nReelStripSize;
setItsCReelStrip(new CReelStrip(nReelStripSize,pReelStripData));
// Set the reel window (visible part of the reel)
switch (nReelWindowSize)
{

case 3:

m_ReelWindowSize = RWS_STANDARD;
cout << “CReel::CReel- Window size = 3,
standard size” << endl;
break;

default:

cout << “CReel::CReel- Window size other than
3 not currently supported” << endl;
break;

}
//#]

}

The CReel destructor has no user defined code and is generated automatically as follows:

CReel::˜CReel( ) {

cleanUpRelations( );

}

Below is the implementation of CReel's “get reel symbol value” operation. Most of the body of this operation is user defined. This operation just uses the CReelStrip's method to get the value of the reel symbol at the given reel stop.

int CReel::GetReelSymbolValueAt(int ReelStop) {

//#[ operation GetReelSymbolValueAt(int)
// get pointer to this reel's reel strip
CReelStrip* pMyReelStrip = getItsCReelStrip( );
// get the integer value of the reel symbol
int nSymbolIntValue = pMyReelStrip->GetReelSymbolValueAt(ReelStop);
//cout << “CReel::GetReelSymbolValueAt- At reel stop position = ” << ReelStop
// << “ reel symbol int. value = ” << nSymbolIntValue << endl;
return (nSymbolIntValue);
//#]

}

Below are implementations of the member variable handling methods (“get” and “set” functions). All this software code is automatically generated. A number of “framework” methods are implemented to do housekeeping work such as assuring that symmetrical relationships between two objects are properly maintained. This is done automatically.

```
int CReel::getM_ReelPosition( ) const {
    return m_ReelPosition;
}
void CReel::setM_ReelPosition(int p_m_ReelPosition) {
    m_ReelPosition = p_m_ReelPosition;
}
int CReel::getM_ReelStripSize( ) const {
    return m_ReelStripSize;
}
void CReel::setM_ReelStripSize(int p_m_ReelStripSize) {
    m_ReelStripSize = p_m_ReelStripSize;
}
REEL_WINDOW_SIZES CReel::getM_ReelWindowSize( ) const {
    return m_ReelWindowSize;
}
void CReel::setM_ReelWindowSize(REEL_WINDOW_SIZES p_m_ReelWindowSize) {
    m_ReelWindowSize = p_m_ReelWindowsize;
}
CReelGroup* CReel::getItsCReelGroup( ) const {
    return itsCReelGroup;
}
void CReel::_setItsCReelGroup(CReelGroup* p_CReelGroup) {
    itsCReelGroup = p_CReelGroup;
}
void CReel::setItsCReelGroup(CReelGroup* p_CReelGroup) {
    if(itsCReelGroup != NULL)
        itsCReelGroup->_removeItsCReel(this);
    _setItsCReelGroup(p_CReelGroup);
}
void CReel::setItsCReelGroup(CReelGroup* p_CReelGroup) {
    if(p_CReelGroup != NULL)
        p_CReelGroup->_addItsCReel(this);
    _setItsCReelGroup(p_CReelGroup);
}
void CReel::clearItsCReelGroup( ) {
    itsCReelGroup = NULL;
}
CReelStrip* CReel::getItsCReelStrip( ) const {
    return itsCReelStrip;
}
void CReel::_setItsCReelStrip(CReelStrip* p_CReelStrip) {
    itsCReelStrip = p_CReelStrip;
}
void CReel::_setItsCReelStrip(CReelStrip* p_CReelStrip) {
    if(itsCReelStrip != NULL)
        itsCReelStrip->_setItsCReel(NULL);
    _setItsCReelStrip(p_CReelStrip);
}
void CReel::setItsCReelStrip(CReelStrip* p_CReelStrip) {
    if(p_CReelStrip != NULL)
        p_CReelStrip->_setItsCReel(this);
    _setItsCReelStrip(p_CReelStrip);
}
void CReel::_clearItsCReelStrip( ) {
    itsCReelStrip = NULL;
}
void CReel::cleanUpRelations( ) {
    if(itsCReelGroup != NULL)
        {
            CReelGroup* current = itsCReelGroup;
            if(current != NULL)
                Current->_removeItsCReel(this);
            itsCReelGroup = NULL;
        }
        if(itsCReelStrip != NULL)
            {
                CReel* p_CReel = itsCReelStrip->getItsCReel( );
                if(p_CReel != NULL)
                    itsCReelStrip->_setItsCReel (NULL);
                itsCReelStrip = NULL;
            }
}
/******************************************************************
            File Path  : gamePlay\MSVC genaric\CReel.cpp
******************************************************************/
```

A visual programming environment like Rhapsody® includes a configuration element that allows the software developer to create different software code images for different purposes. First, the Rhapsody® tool provides interfaces or frameworks for several real time and desktop operating systems. This means that the Rhapsody® tool can generate software code that will run in a variety of environments. The software developer can take advantage of this feature to build a prototype image that runs on a standard Windows operating system and then uses the same model to generate code that runs on an embedded Windows platform such as Windows CE. To do this, the software developer only needs to change a configuration setting. Specifically, with the Rhapsody® tool, the software developer changes the “environment” setting from standard “Microsoft” to “MicrosoftWinCE”. Second, other configuration settings enable the software developer to create software code that contains debugging and animation information that is very useful for development and testing.

After the software code is automatically generated, the code must go through a standard build process to create an executable file or image that can be run on a target platform, such as the Elan SC520 microcontroller commercially available from Advanced Micro Devices, Inc. (AMD) of Sunnyvale, Calif. This process is the same as the process manually written code goes through: pre-process, compile, link, and, if necessary, locate. The result is the object necessary to run on the given target platform. In some cases this may be a re-locatable image file, while in other cases this may be an absolute binary image that must be burned in a memory device.

While the present invention has been described with reference to one or more particular embodiments, those skilled in the art will recognize that many changes may be made thereto without departing from the spirit and scope of the present invention. For example, other visual software development tools may be used instead of Rhapsody, including Rational Rose RT/UML enterprise suite by Rational Software Corporation of Lexington, Mass. and Cupertino, Calif.; Telelogic Tau 4.1 by Telelogic North America, Inc. of Mt. Arlington, N.J.; and GD Pro and Describe Software by Embarcadero Technologies, Inc. of San Francisco, Calif. Each of these embodiments and obvious variations thereof is contemplated as falling within the spirit and scope of the claimed invention, which is set forth in the following claims.

What is claimed is:

1. A method for generating real-time embedded software code for a game of chance, comprising:
preparing an analysis model for the game of chance, the analysis model describing functionality to be included in the software code;
preparing a design model for the game of chance, the design model including a plurality of objects for realizing the functionality in the analysis model; and
generating software code for the game of chance from the design model, the software code including at least a portion that is automatically generated using a software development tool.

2. The method of claim 1, wherein the analysis model, the design model, and the software code are prepared using the software development tool.

3. The method of claim 1, wherein the design model defines static relationships between the objects and dynamic behavior of the objects, the automatically generated portion of the software code including the static relationships between the objects and the dynamic behavior of the objects.

4. The method of claim 3, wherein the design model includes object model diagrams and state charts, the object model diagrams defining the static relationships between the objects, the state charts defining the dynamic behavior of the objects.

5. The method of claim 1, wherein the functionality described by the analysis model is organized into use cases.

6. The method of claim 5, wherein the analysis model includes use case diagrams and sequence diagrams, the use case diagrams defining relationships between the use cases and external actors outside the game of chance, the sequence diagrams defining a sequence of interactions between the use cases and the external actors.

7. The method of claim 1, wherein the analysis model and the design model conform to the Unified Modeling Language (UML) standard.

8. The method of claim 1, wherein the game of chance is a slot reel game including a plurality of symbol-bearing reels that are rotated and stopped to place symbols on the reels in visual association with a display area.

9. The method of claim 1, wherein the software code includes another portion that is manually prepared.

10. The method of claim 9, wherein the objects are associated with operations, the manually prepared portion of the software code defining the operations.

11. The method of claim 1, further including the steps of modifying the design model and automatically modifying the software code in response to modifying the design model.

12. The method of claim 1, further including the steps of modifying the software code and automatically modifying the design model in response to modifying the software code.

13. An apparatus for generating real-time embedded software code for a game of chance, comprising:
means for preparing an analysis model for the game of chance, the analysis model describing functionality to be included in the software code;
means for preparing a design model for the game of chance, the design model including a plurality of objects for realizing the functionality in the analysis model; and
means for generating software code for the game of chance from the design model, the software code including at least a portion that is automatically generated by the generating means.

14. The apparatus of claim 13, wherein the design model defines static relationships between the objects and dynamic behavior of the objects, the automatically generated portion of the software code including the static relationships between the objects and the dynamic behavior of the objects.

15. The apparatus of claim 14, wherein the design model includes object model diagrams and state charts, the object model diagrams defining the static relationships between the objects, the state charts defining the dynamic behavior of the objects.

16. The apparatus of claim 13, wherein the functionality described by the analysis model is organized into use cases.

17. The apparatus of claim 16, wherein the analysis model includes use case diagrams and sequence diagrams, the use case diagrams defining relationships between the use cases and external actors outside the game of chance, the sequence diagrams defining a sequence of interactions between the use cases and the external actors.

18. The apparatus of claim 13, wherein the analysis model and the design model conform to the Unified Modeling Language (UML) standard.

19. The apparatus of claim 13, wherein the game of chance is a slot reel game including a plurality of symbol-bearing reels that are rotated and stopped to place symbols on the reels in visual association with a display area.

20. The apparatus of claim 13, wherein the software code includes another portion that is manually prepared using the generating means.

21. The apparatus of claim 20, wherein the objects are associated with operations, the manually prepared portion of the software code defining the operations.

22. The apparatus of claim 13, further including means for automatically modifying the software code in response to modifying the design model.

23. The apparatus of claim 13, further including means for automatically modifying the design model in response to modifying the software code.

24. A collection of products for developing a game of chance in a common visual programming environment, comprising:
an analysis model for the game of chance, the analysis model describing functionality to be included in the software code;
a design model for the game of chance, the design model including a plurality of objects for realizing the functionality in the analysis model; and
software code for the game of chance, the software code including at least a portion that is automatically generated from the design model.

25. The collection of claim 24, wherein the design model defines static relationships between the objects and dynamic behavior of the objects, the automatically generated portion of the software code including the static relationships between the objects and the dynamic behavior of the objects.

26. The collection of claim 25, wherein the design model includes object model diagrams and state charts, the object model diagrams defining the static relationships between the objects, the state charts defining the dynamic behavior of the objects.

27. The collection of claim 24, wherein the functionality described by the analysis model is organized into use cases.

28. The collection of claim 27, wherein the analysis model includes use case diagrams and sequence diagrams, the use case diagrams defining relationships between the use cases and external actors outside the game of chance, the sequence diagrams defining a sequence of interactions between the use cases and the external actors.

29. The collection of claim 24, wherein the analysis model and the design model conform to the Unified Modeling Language (UML) standard.

30. The collection of claim 24, wherein the game of chance is a slot reel game including a plurality of symbol-bearing reels that are rotated and stopped to place symbols on the reels in visual association with a display area.

31. The collection of claim 24, wherein the software code includes another portion that is manually prepared.

32. The collection of claim 31, wherein the objects are associated with operations, the manually prepared portion of the software code defining the operations.

33. The collection of claim 24, wherein the software code is automatically modified in response to modifying the design model.

34. The collection of claim 24, wherein the design model is automatically modified in response to modifying the software code.
